(19) United States
(12) Patent Application Publication
(10) Pub. No.: US 2004/0252115 A1
(43) Pub. Date: Dec. 16, 2004

(54) Image refresh in a display

(76) Inventor: Olivier Boireau, Birminingham (GB)

Correspondence Address: MCGARRY BAIR PC, 171 MONROE AVENUE, N.W., SUITE 600, GRAND RAPIDS, MI, 49503, US

(21) Appl. No.: 10/486,175

(22) PCT Filed: Aug. 5, 2002
(86) PCT No.: PCT/GB02/03589

(30) Foreign Application Priority Data
Aug. 3, 2001 (GB) 0119002.4

(51) Int. Cl. G09G 5/00

(52) U.S. Cl. 345/211

(57) ABSTRACT

A method of refreshing an image on a display device includes receiving an image to be displayed (810) at a display (110); processing said received image to obtain at least one image parameter relating to said image to be displayed (810); and varying a rate (930) at which said displayed image is refreshed based on said image parameter. A video or image display device, and a display driver, have also been described. This provides the following advantages that the refresh rate is constantly being varied in response to the images being displayed so as to constantly minimise the power consumption of the display device without noticeable flickering of the display device. Furthermore, the quality of the image is maintained at a continuous level, irrespective of the changes in, for example the complexity or number of colours used in a particular image.

### FIELD OF THE INVENTION

This invention relates to a method of altering the rate at which a display device, such as a liquid crystal display (LCD), is refreshed. The invention is applicable to, but not limited to, display devices used in battery powered apparatus, such as personal digital assistants (PDAs) or mobile phones, where battery power to operate and refresh the display is limited.

### BACKGROUND OF THE INVENTION

Future generation mobile and fixed communication systems are expected to provide the capability for video and image transmission as well as the more conventional voice and data services. As such, video and image services will become more prevalent and improvements in video/image compression technology are likely to be needed in order to match the consumer demand within the available communication bandwidth.

Current transmission technologies, which are particularly suited to image or video applications, focus on interpreting image data at the transmission source. Subsequently, the interpretation data, rather than the image itself, is transmitted and used at the destination communication unit.

Such communication systems are often bandwidth constrained because of the communication channel. In constraining the amount of information to be transmitted between transmitting and receiving units, video and image compression techniques have been developed. The use of video and image compression techniques allows the system designer to optimise and prioritise the video signals and images that are to be transmitted.

One example would be to transmit interpretation data in compressed form. The ability for a video or image decoder in a communication device to only process interpretation data minimises the amount of processing required to recover a particular image or series of images. Consequently, the communication device is able to conserve battery power, which is of immense benefit in a portable communication device.

In the context of the present invention, and the indications of the advantages of the present invention over the known art, the expression ‘image’ is used to encompass various video techniques including video that is streamed or encoded (block-based, DCT-based, object-based or other) for storage with the ability to be viewed later and/or image transmission techniques including still image transmission.

In the field of this invention it is known that an image presented on a display device fades with time. Therefore it is necessary for the image to be refreshed in order for it to remain clear to a viewer/user. If the refresh rate is not sufficiently high, the image degrades enough for the human eye to perceive the image degradation during a display refresh operation. Hence, a too-low refresh rate causes a perceptual flickering of the displayed image to the user.

Furthermore, the more colours that are used in a displayed image, the more noticeable that any flickering is to a user. Therefore, it is known that images with more colours often require a higher refresh rate than images with fewer colours.

However, the higher the refresh rate, the higher the power consumption. In particular, in order for a display device to continuously display images having many colours, the display is designed to have a constant high refresh rate, and thereby a constant high power consumption. Therefore, a display arrangement designer is left with a trade-off of perceived image quality versus power consumption.

Furthermore, this approach has the disadvantage that conventional apparatus use a display device that has such a fixed refresh rate. In order for there to be minimal perceptual flickering, this refresh rate must be fixed at the highest value in order for the most intricate images to be displayed. This means that the power consumption of the display device is constantly set to its highest level.

Thus there exists a need in the field of the present invention for an improved display arrangement wherein the abovementioned disadvantages associated with prior art arrangements may be alleviated.

### STATEMENT OF INVENTION

In accordance with a first aspect of the present invention, there is provided a method of refreshing an image on a display device, as claimed in claim 1.

In accordance with a second aspect of the present invention, there is provided an image or video communication device, as claimed in claim 13.

In accordance with a third aspect of the present invention, there is provided a display driver for controlling a refresh rate of a display device, as claimed in claim 15.

In accordance with a fourth aspect of the present invention, there is provided a storage medium storing processor-implementable instructions, as claimed in claim 16.

In accordance with a fifth aspect of the present invention, there is provided a video or image display device, as claimed in claim 17.

In accordance with a sixth aspect of the present invention, there is provided a display driver for controlling the refresh rate of a display device, as claimed in claim 28.

Further aspects of the invention are as claimed in the dependent claims.

In summary, the present invention provides a means of varying the refresh rate of a display, dependent upon the image being displayed, in order to reduce the overall power consumption of a display device.

### BRIEF DESCRIPTION OF THE DRAWINGS

Exemplary embodiments of the present invention will now be described, with reference to the accompanying drawings, in which:

FIG. 1 shows a block diagram of a subscriber unit adapted to support the inventive concepts of the preferred embodiments of the present invention.

FIG. 2 shows a graphical illustration of a display refresh operation.

FIG. 3a and FIG. 3b show timing diagrams of a subscriber unit adapted to support the inventive concepts of the preferred embodiments of the present invention.

FIG. 4 shows a graphical illustration of power consumption versus refresh rate for a display refresh operation.

FIG. 5 shows a graphical illustration of power consumption versus a number of colours to be displayed for a display refresh operation.

FIG. 6 shows a graphical illustration of flicker versus a number of colours to be displayed for a display refresh operation.

FIG. 7 shows a graphical illustration of a minimum refresh rate versus a number of colours to be displayed for a display refresh operation, in accordance with a preferred embodiment of the present invention.

FIG. 8 shows a flowchart of a method of refreshing an image on a display device, in accordance with a preferred embodiment of the present invention.

FIG. 9 shows a flowchart of a more detailed method of refreshing an image on a display device, in accordance with a preferred embodiment of the present invention.

FIG. 10 illustrates a block diagram of a liquid crystal display (LCD) control/driver circuit, in accordance with the preferred embodiment of the present invention.

### DESCRIPTION OF PREFERRED EMBODIMENTS

The preferred embodiment of the present invention is described with reference to a portable cellular phone capable of operating in, for example, the next generation of wireless cellular technology. However, it is within the contemplation of the present invention that the inventive concepts described herein are equally applicable to any other video or image display device, such as a personal data assistant (PDA), a portable or mobile radio, a laptop computer or a wirelessly networked PC or indeed any other digital device supporting video/image transmissions.

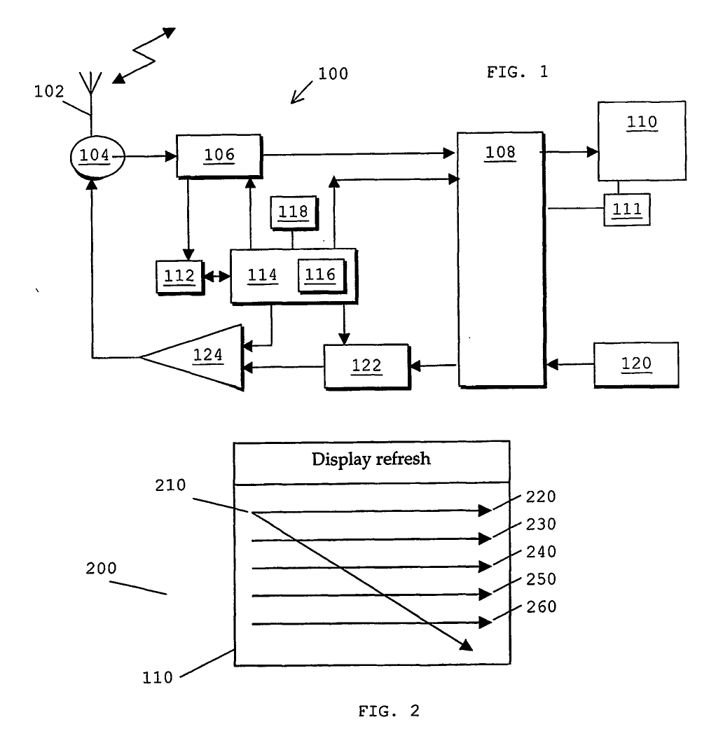

Referring first to FIG. 1, there is shown a block diagram of a cellular subscriber unit 100 adapted to support the inventive concepts of the preferred embodiments of the present invention. The subscriber unit 100 contains an antenna 102 preferably coupled to a duplex filter or circulator 104 that provides isolation between receiver and transmitter chains within the subscriber unit 100.

The receiver chain, as known in the art, includes scanning receiver front-end circuitry 106 (effectively providing reception, filtering and intermediate or base-band frequency conversion). The scanning front-end circuit 106 is serially coupled to a signal processing function 108. An output from the signal processing function 108 is provided to a suitable output device 110, such as a screen or flat panel liquid crystal display. The screen or flat panel display 110 preferably includes a display driver 111.

In the preferred embodiment of the present invention, each time an image on the screen or flat panel display 110 is to be refreshed, each pixel within the display device is typically refreshed, as illustrated in FIG. 2. FIG. 2 shows one example of a display refresh operation 200, in accordance with a preferred embodiment of the invention. Each pixel of the screen or flat panel display 110 is refreshed in a particular order, for example by starting at the top left corner 210 of the screen and refreshing each pixel row-by-row 220-260. In this manner, the whole screen of the display is refreshed each cycle by refreshing each and every line (row).

However, it is within the contemplation of the invention that alternative refresh procedures can be employed, such as when an interleaving operation is used. Such a procedure involves the alternate refreshment of odd and even horizontal lines (rows). In this manner, the whole screen of the display is refreshed, alternate line (row) by alternate line (row), i.e. interleaving.

Refreshing a whole image, or alternate refreshing of add and even lines of an image, provides the advantage that the refresh operation is relatively simple, without the need for the display hardware and/or software to be required to dynamically vary where and when different regions of an image are to be refreshed. This simplifies the hardware required, and also reduces the amount of processing required in order for an image to be refreshed.

Referring back to FIG. 1, the receiver chain also includes received signal strength indicator (RSSI) circuitry 112, which in turn is coupled to a controller 114 for maintaining overall subscriber unit control. The controller 114 is also coupled to the scanning receiver front-end circuitry 106 and the signal processing function 108 (generally realised by a DSP) for receiving a transmitted video or image signal.

The controller 114 may therefore receive bit error rate (BER) or frame error rate (FER) data from recovered information. The controller is also coupled to a memory device 116 that stores operating regimes, such as decoding/encoding functions and the like. In accordance with the preferred embodiment of the present invention, the processor 108 and/or controller 114, together with the display driver 111, has/have been adapted such that a refresh rate of images displayed on the screen or flat panel display 110 is ‘varied’ across a range of rates in response to the image being displayed.

It is within the contemplation of the invention that the inventive concepts described herein apply equally to images received by the communication unit, or previously stored within the communication unit for subsequent display. Indeed, the inventor of the present invention has recognised that a particular advantage of the inventive concepts results from displaying simple images, for example menus etc., that are likely to be included among the resources provided on the communication unit itself. In particular, when the communication unit, for example cellular phone, is in a standby mode of operation (i.e. switched on but not being used), there is frequently a basic image that is displayed on the display. This basic image, in standby mode, does not require a high refresh rate.

The generally assumed operational profile of a cellular telephony unit suggests that the unit is typically in an idle mode for 90% of its operating time and actively involved in calls for the remaining 10% of its operating time. Cellular phone manufacturers publish figures for the “standby time” of their products, which equates to the ability of the battery to maintain its charge to sustain the cellular telephone in an idle mode of operation. Such figures are deemed highly influential in attracting purchasers of cellular phone equipment.

Conversely in the private mobile radio field, a trunked radio is assumed to be in an idle mode for 75% of its operating time, in a receive mode (receiving broadcast, signalling, synchronisation transmissions etc.) for 20% of its operating time and transmitting/receiving in a call for 5% of its operating.

Hence, the inventive concepts of the present invention provide benefits when processing newly received images. In addition, the inventive concepts also allow a reduction in the power consumption of a display when in stand-by mode in, for example, either of the above communication products thereby substantially increasing the standby time of the product. For portable products, that are idle for a significant amount of time, the opportunity to reduce power consumption during this time is invaluable.

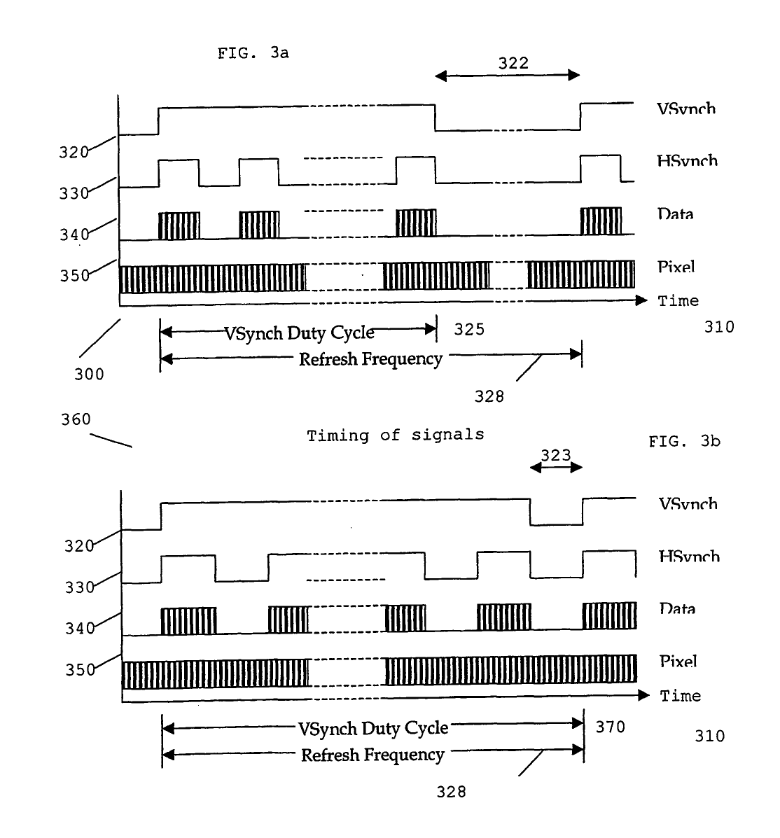

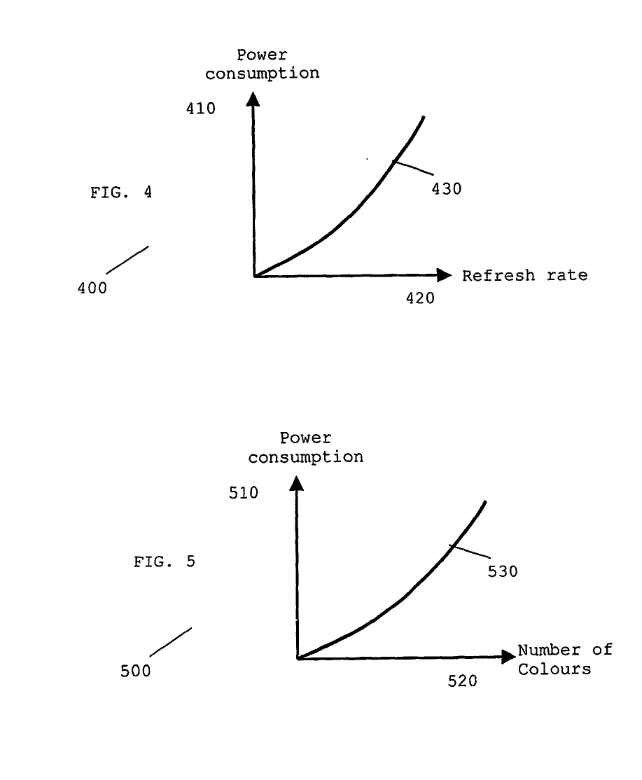

A timer 118 is operably coupled to the controller 114 to control the timing of operations (including transmission or reception of time-dependent signals) within the cellular subscriber unit 100. The timer, together with the display driver 111, processor 108 and/or controller 114, has also been adapted to control the refresh rate of the displayed image of the screen or flat panel display 110. The preferred operation is described in greater detail with reference to FIG. 3a.

In accordance with a first embodiment of the present invention, the display refresh operation is controlled in response to a status of selected signal timings 310, as shown in the graph 300 of FIG. 3a. The preferred embodiment of the present invention utilises timing of signals that include vertical synchronisation (VSynch) 320, horizontal synchronisation (HSynch) 330, data 340 and pixel clock 350, associated with the display in conjunction with the received video or image signal(s). The frequencies of Hsynch 330 and the pixel clock 350 are multiples of the Vsynch 320 frequency.

The Vsynch signal 320 is used to inform the display device 110 when to commence incorporating the next whole image or commence refreshing portions of the current image. The Vsynch signal 320 essentially controls when the vertical alignment of the refresh operation returns to the top of the display device, as shown by the top left hand corner 210 of FIG. 2. Thus, for the illustrated embodiment, the Vsynch signal 320 essentially sets a display refresh rate.

A preferred embodiment of the invention, as shown in FIG. 3a, uses the duty cycle 325 of the VSynch signal 320, namely a leading-edge pulse to re-commence refreshing the display, thereby setting a refresh duty cycle. However, a skilled artisan would recognise that alternative signal timings and alternative triggering mechanisms, such as using a trailing-edge pulse, return-to-zero (RZ) pulses, etc. and an alternative display arrangement could still benefit from the inventive concepts described herein.

Once the refresh cycle reaches the bottom right hand corner of the display device 110, the display refreshing operation is paused 322 until the next leading-edge pulse of the VSynch signal 320. By controlling the time for which the whole display refreshing operation is paused 322, it is possible to vary the refresh rate of the display device 110.

The Hsynch signal 330 is used to inform the display device when to begin to draw the next horizontal line (row) of pixels. Hence, the Hsynch signal 330 controls when the horizontal alignment of the refresh operation returns to the start of a new row, at the left hand side of the screen of the display device 110.

The Data signal 340 contains the data for each pixel of the display device. This data is divided into blocks, where each block represents a row on the display device.

As shown in FIG. 3a and FIG. 3b, these blocks correspond to the Hsynch timing signal 330. Within each block, the pixel data is refreshed at a rate corresponding to the pixel clock 350.

Preferably in the first-embodiment, the HSynch signal 330 and the pixel clock 350 are substantially fixed, with only the VSynch signal 320 varied to control the rate of refresh (noting that the Data signal is dependent upon each of the other three timing signals). However, it is within the contemplation of the invention that other devices may be refreshed in response to varying one or more of the, or other, timing signals, such that the time it takes for a single refresh cycle can be altered. For example, the pixel clock timing can be adjusted, with a longer clock-pulse duty cycle consequently creating a longer display refresh operation. Advantageously, by use of software control and adjustment of signal timing within the display driver/control circuit, varying of a display refresh rate based on an image to be displayed is easily accomplished.

In this manner, instead of controlling the period of time (pause 322 in FIG. 3a) between each refresh cycle in order to vary the refresh rate, the period taken for each individual refresh operation can be controlled to vary the refresh rate. An example of this is shown in FIG. 3b, highlighting a timing arrangement 360 that indicates a longer refresh operation. The longer refresh operation is achieved by controlling Vsynch 320 to have a much reduced ‘low-period’, thereby providing a much reduced pause period of time 323, compared to the pause period 322 of FIG. 3a. Since the time taken for each refresh cycle can be varied, it may not therefore be necessary to implement a ‘pause’ between each refresh cycle.

Hence, the present invention provides a means of varying a display refresh rate depending on the image being displayed. Such a variable display refresh mechanism allows the cellular subscriber unit (or other video or image device) to dynamically optimise the power consumption of a display device with respect to the power required to facilitate image refreshing on a display. This is more clearly shown with reference to the graph 400 of FIG. 4.

The graph 400 of FIG. 4 illustrates how the refresh rate 420 affects the power consumption 410 of the display device. In order to keep the power consumption to a minimum it is necessary to have as low a refresh rate as possible. Therefore, a reduction in the refresh rate provides a comparable, but generally non-linear, reduction in the power consumption of the display device 110 as shown by curve 430.

Referring back to FIG. 1 for completeness, the transmit chain of the cellular subscriber unit 100 essentially includes an input device 120, such as a keypad, coupled in series through transmitter/modulation circuitry 122 and a power amplifier 124 to the antenna 102. The transmitter/modulation circuitry 122 and the power amplifier 124 are operationally responsive to the controller.

Of course, the various components within the cellular subscriber unit 100 can be realised in discrete or integrated component form. Furthermore, it is within the contemplation of the invention that any device capable of displaying received video or images can benefit from the inventive concepts described herein.

In accordance with the preferred embodiment of the present invention, the decision as to whether to dynamically adapt the display refresh rate is made in response to any one or more of a number of image parameters related to the image to be displayed. One such preferred image parameter is the number of colours, to be used in displaying the image, as shown in FIG. 5. An alternative image parameter may be, for example, a range of shades. The graph 500 of FIG. 5 illustrates how the power consumption 510 of the display device is affected by the number of colours 520 to be displayed. In order to keep the power consumption to a minimum it is desirable to have as few colours as possible. Therefore, a reduction in the number of colours to be used provides a comparable, but generally non-linear, reduction in the power consumption of the display device 110 as shown by curve 530.

An example of a technology capable of performing such colour selection is MPEG compression—one of the International Standard Organisation's (ISO) standards for video encoding. The ISO MPEG4 standard contains tools for individually coding video objects, their shape and their composition in an audio-visual scene.

A yet further alternative image parameter that could be used, for example, is to determine the number of pixels that have been changed between consecutive frames, by say employing a frame-by-frame comparison of the image. The primary consideration in the selection of a suitable image parameter is that it has a direct relationship with the refresh requirements of the image to be displayed. It is therefore within the contemplation of the invention that a person skilled in the art could readily use the teachings of the present invention with any other parameter(s) related to the image to be displayed.

Any further alternative image parameter may be used that relates to the visually perceptible flickering of an image to be displayed. Thus, further alternative image parameters might include the contrast range of an image, the contrast variations throughout the image, etc.

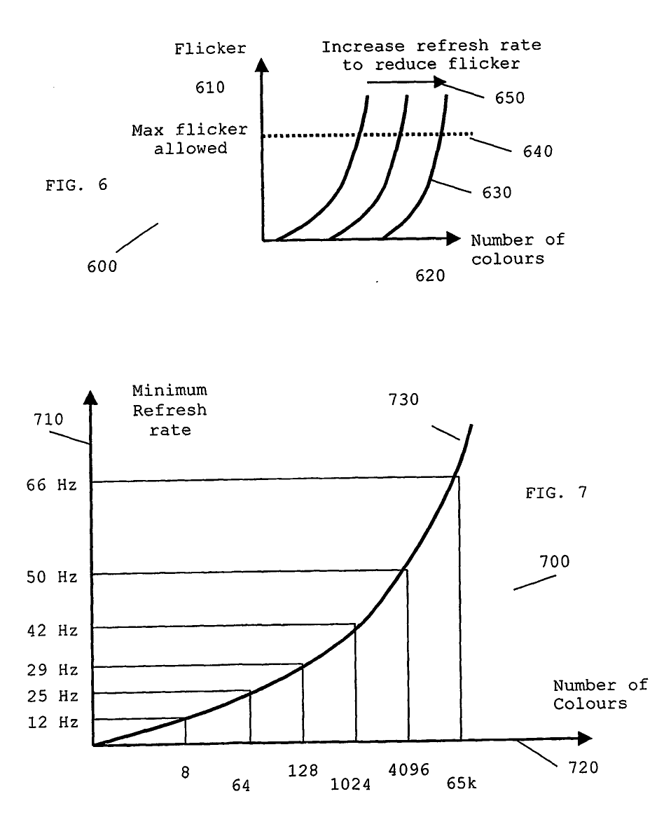

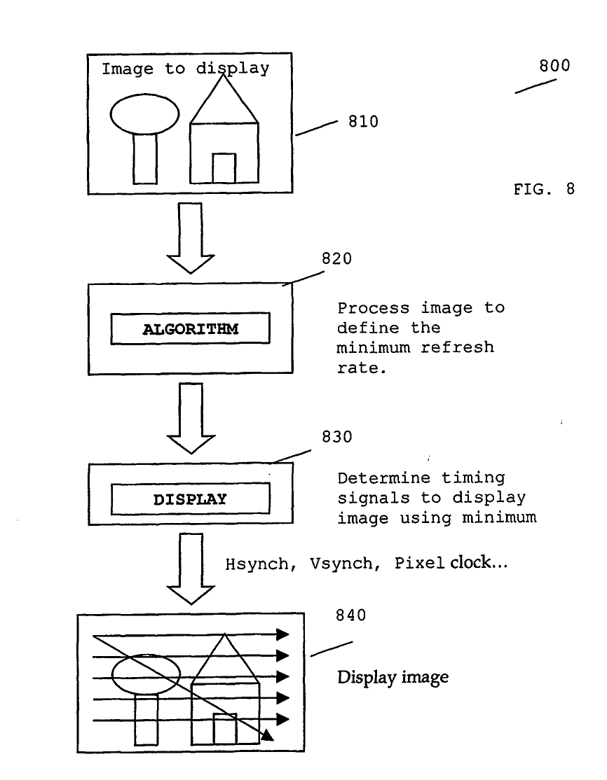

The primary design consideration in the preferred embodiment is the selection of an optimum refresh rate for the display, to avoid any perceptual flickering of the displayed image to the display viewer/user. As such, a maximum allowable flicker (equating to a minimum refresh rate) of the displayed image can be determined, as illustrated in the graph 600 of FIG. 6. The selected maximum allowable flicker rate is preferably imperceptible to the user of the display. The graph 600 shows that as the number of colours 620 increases, so does the amount of flickering 610. In order to keep the flicker 610 below a particular maximum flicker level 640, when displaying an increased number of colours, it is necessary to have a comparable increase in the refresh rate to maintain the same flicker level, as shown by curves 630. This relationship is shown clearly in FIG. 7.

Referring now to the graph 700 of FIG. 7, a graphical relationship 730 between the number of colours 720 in an image to be displayed and the optimum refresh rate 710, required in order to substantially avoid flickering, is illustrated. Such a graph (or indeed arithmetic function) could be provided by either the manufacturer of the display device, or produced through testing of the device to determine typical or worst-case user perception levels for different flicker rates. For the preferred embodiment of the present invention, the values in the graph 700 (or arithmetic function) are used to create a lookup table in the memory device 116, as illustrated in Table 1.

TABLE 1

| Number of colours | Refresh rate |
|---|---|
| in the picture | (Hz) |
| 8 | 12 |
| 16 | 17 |
| 32 | 21 |
| 64 | 25 |
| 128 | 29 |
| 256 | 33 |
| 512 | 37 |
| 1,024 | 42 |
| 2,048 | 46 |
| 4,096 | 50 |
| 8,000 | 54 |
| 16,000 | 58 |
| 32,000 | 62 |
| 65,000 | 66 |

Once the aforementioned graph (or arithmetic function) has been downloaded to the cellular subscriber unit 100, it is preferably stored in the memory device 116 of FIG. 1. The memory device 116 could be either a read-only memory (ROM), in which case the data is fixed for that memory device, or random access memory (RAM) in which case the data can be adaptable for different image formats or different communication devices (for example black and white images on a closed circuit television (CCTV) link).

The graph (or arithmetic function) can then be executed by the processor 108 and/or controller 114 of the cellular subscriber unit 100 to vary optimally the refresh rate of the screen or flat panel display 110.

Referring now to FIG. 8, a flow diagram 800 is shown of the preferred method of the present invention for varying a refresh rate associated with a video or image frame. An image is received for displaying on a display, as shown in step 810. An algorithm processes the image to be displayed, and extracts image parameter data, in order to determine an optimum refresh rate, as in step 820. The optimum refresh rate is selected such that the power consumption is kept to a minimum without there being any noticeable flickering to the display user/viewer.

In the preferred embodiment, the algorithm in step 820 uses a lookup table to determine the optimum refresh rate for the image being displayed. Alternatively, as indicated above, the algorithm could use an arithmetic function, representative of the aforementioned lookup table in order to determine an optimum refresh rate.

A display driver, preferably controlled by a processor or controller, uses the output of the algorithm to determine optimum timing parameters for refreshing the image on the display, for example Vsynch, Hsynch, pixel clock, as shown in step 830. The display driver then controls the image refresh operation of the display, using the above timing parameters, in order to maintain a particular perceived quality of displayed image, as in step 840.

It is within the contemplation of the invention that a cellular subscriber unit 100 (or other video/image device) may be re-programmed with an algorithm supporting the inventive concepts of the present invention, as described above. More generally, according to the preferred embodiment of the present invention, such re-programming to dynamically adapt a refresh rate of a display may be implemented in a respective cellular subscriber unit 100 (or other video/image device) in any suitable manner. For example, a new memory chip may be added to a conventional cellular subscriber unit 100 (or other video/image device).

Alternatively, existing parts of a conventional cellular subscriber unit 100 (or other video/image device) may be adapted, for example by reprogramming one or more processors therein. As such the required adaptation may be implemented in the form of processor-implementable instructions stored on a storage medium, such as a floppy disk, hard disk, programmable ROM (PROM), RAM or any combination of these or other storage multimedia.

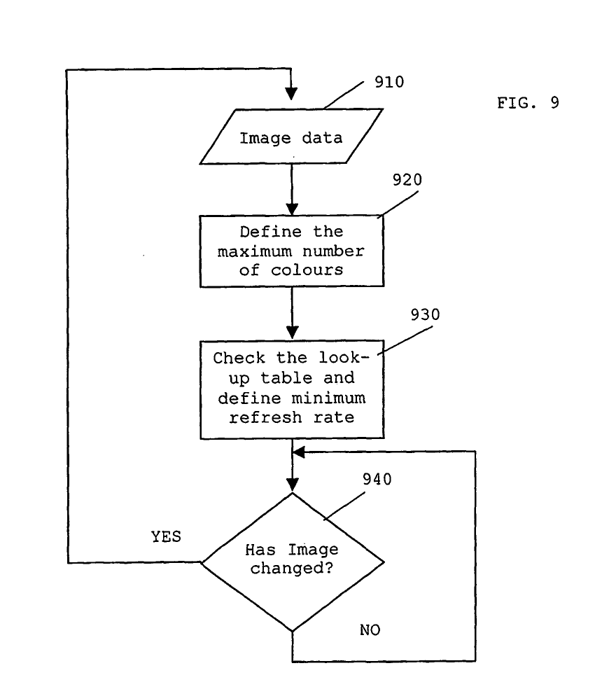

Referring now to FIG. 9, a flow chart 900 describes the algorithm in step 820 of FIG. 8 in more detail, in accordance with the preferred embodiment of the present invention. The algorithm includes receiving image data, as in step 910. The algorithm proceeds to process the received image data to determine a value for selected image parameters relating to the image to be displayed, as shown in step 920.

For example, in accordance with the preferred embodiment, the maximum number of colours (say 512) in the image to be displayed is determined. The algorithm then checks this value with the lookup table to define the optimum refresh rate required to avoid flickering (which in the above case is 37 Hz), as in step 930. The optimum refresh rate for the image parameter value is then used by the display driver to determine the required timing signals to be used to update/refresh the image on the display. Whilst the image to be displayed remains the same, the algorithm maintains the same minimum refresh rate, as shown in step 940. However, when the image changes, the algorithm receives data for the new image, and the process repeats, as shown. In this manner, the display driver continuously minimises the display refresh rate, thereby minimising power consumption of the display, whilst ensuring that the refresh operation is imperceptible to the user.

It is within the contemplation of the invention that the above image change may be a new image frame, or comprise a number of changed pixel values. Furthermore, it is within the contemplation of the invention that any number of alternative image evaluation techniques may be used to obtain the image parameters that are best suited to determine the optimum refresh rate.

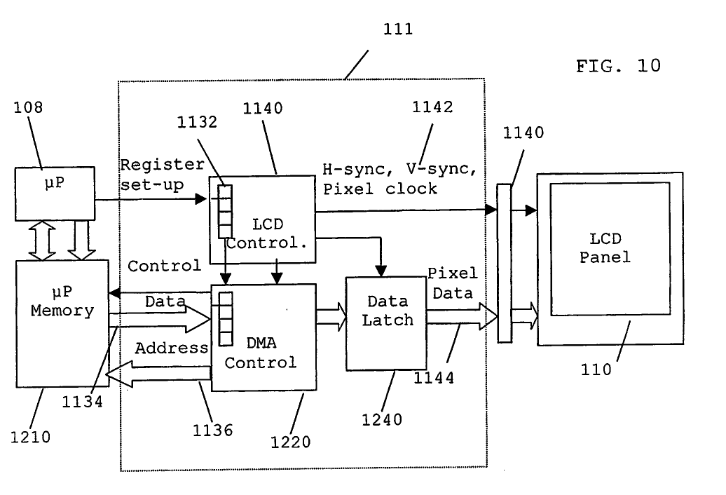

FIG. 10 illustrates a block diagram of a liquid crystal display (LCD) control/driver circuit 1200, in accordance with the preferred embodiment of the present invention. A microprocessor, for example the microprocessor 108 of FIG. 1, initialises an LCD controller 1140 and a DMA controller 1220 by way of control registers 1132. The microprocessor 108 manages the contents of image memory 1210 via an address bus 1134 and a data bus 1136.

The LCD controller 1140 is also connected to an LCD panel 110 by way of a timing link 1142 that provides, inter-alia, timing signals such as horizontal (H)-sync, vertical (V)-sync and pixel clock. The DMA controller drives pixel data bus 1144, by way of a data latch 1240, providing pixel data to the LCD panel 110. For the illustrated embodiment there is also provided a connector 1140 between the LCD controller 1140 and the LCD panel 110. The LCD panel 110 includes an LCD display and control circuitry (not shown).

The LCD controller 1140 also provides timing control signals to the LCD panel 110, the DMA controller 1220 and the data latch 1240 to coordinate the retrieval and making available of pixel data. The DMA controller 1220 retrieves pixel data for the image to be displayed from the memory device 1210 via address bus 1134 and data bus 1136. The pixel data retrieved from the memory is then passed to a data latch 1240.

The LCD panel 110 receives the timing signals provided by the LCD controller 1140 and, in response to the timing signals, retrieves the data for each pixel. The LCD panel 110 then systematically displays the corresponding image one pixel at a time.

Thus, for the preferred embodiment of the present invention, the refresh rate can be varied by varying the timing signals provided by the LCD controller 1140. Preferably the microprocessor 108 instructs or controls the LCD controller 1140 in order to vary the timing signals.

It will be appreciated that the LCD control/driver circuit 1200 illustrated in FIG. 10 is only an example of a suitable LCD driver circuitry apparatus, and that any other suitable circuitry known may alternatively be adapted to facilitate and perform the inventive concepts described herein.

As will be appreciated by those skilled in the art, the present invention is capable of being implemented solely by software instructions executed on the processor 108. In this way, standard display driver circuitry etc. can be utilised, without the need for specialised or adapted hardware/components. Thus, costs in implementing the present invention can be kept to a minimum.

It will be understood that the display refresh operation described above provides at least some of the following advantages:

(i) The refresh rate is constantly being varied in response to the images being displayed so as to keep the power consumption of the display device to a minimum without noticeable flickering of the display device to the display viewer/user.

(ii) The quality of the image may be maintained at a continuous level, irrespective of the changes in, for example the complexity or number of colours used in, a particular image.

(iii) Power consumption of a display device is dynamically optimised whilst maintaining a given quality of image.

Thus, an improved display arrangement has been described wherein the aforementioned disadvantages associated with prior art approaches have been substantially alleviated.

1. A method of refreshing an image on a display, the method comprising the steps of:
receiving an image to be displayed at a display;
processing said received image to obtain at least one image parameter relating to said image to be displayed; and
varying a rate at which said displayed image is refreshed based on said image parameter.

2. The method of refreshing an image on a display according to claim 1, wherein the step of varying further includes the step of:
optimising a power consumption level of the display whilst maintaining a quality level of the displayed image.

3. The method of refreshing an image on a display according to claim 1, the method further characterised by the step of:
applying a refresh operation across a whole image to be displayed.

4. The method of refreshing an image on a display according to claim 1, wherein the step of varying a refresh rate includes at least one of: varying a refresh duty cycle, varying a rate of pixel refresh.

5. The method of refreshing an image on a display according to claim 1, wherein the step of varying a refresh rate includes varying a timing signal associated with the image to be displayed, for example under control of software.

6. The method of refreshing an image on a display according to claim 5, wherein varying a timing signal includes varying at least one of the following timing parameters: a vertical synchronisation, a horizontal synchronisation, data, pixel rate.

7. The method of refreshing an image on a display according to claim 6, wherein the step of varying a refresh rate includes the step of:
varying a timing of pulses of the vertical synchronisation signal, thereby controlling a duty cycle of a refresh operation.

8. The method of refreshing an image on a display according to claim 1, wherein the at least one image parameter relating to said image to be displayed includes a number of colours or shades of colour in an image to be displayed.

9. The method of refreshing an image on a display according to claim 1, the method further comprising the step of:
using a lookup table or an arithmetic function relating to the at least one image parameter in order to select an improved refresh rate.

10. The method of refreshing an image on a display according to claim 1, the method further characterised by the steps of:
determining a minimum refresh rate equating to a maximum allowable flicker of the displayed image; and
varying said display refresh at a rate to avoid substantially any perceptual flickering of said displayed image.

11. The method of refreshing an image on a display according to claim 1, wherein the refresh rate is dynamically adapted when a new image or portion of an image to be displayed is received at said display.

12. The method of refreshing an image on a display according to claim 1, the method further comprising the step of:
refreshing an image to be displayed by refreshing at least one of:
a portion of an image
a full-screen image,
an image by means of a row-by-row refresh an image by means of an interleave refresh operation.

13. An image or video communication device, adapted to perform the steps of claims 1.

14. The image or video communication device according to claim 13, wherein the device is one of:
a cellular phone, a portable or mobile radio, a personal digital assistant, a laptop computer, and a wirelessly networked PC.

15. A display driver for controlling the refresh rate of a display device, adapted to perform the steps of claims 1.

16. A storage medium storing processor-implementable instructions for controlling one or more processors to carry out the steps of claims 1.

17. A video or image display device comprising:
a display for displaying an image;
a processor, operably coupled to said display, for processing said received image to obtain at least one image parameter relating to said image to be displayed; and
means, operably coupled to said processor, for varying a rate at which said displayed image is refreshed based on said image parameter.

18. The video or image display device according to claim 17, wherein the means for varying a refresh rate applies a refresh operation across a whole image to be displayed.

19. The video or image display device according to claim 17, wherein the means for varying a refresh rate includes means for varying a refresh duty cycle and/or means for varying a rate of pixel refresh.

20. The video or image display device according to claims 17, the device further comprising a timer operably coupled to said processor for varying a timing of a refresh rate by varying a timing of a refresh control signal associated with the image to be displayed.

21. The video or image display device according to claim 20, wherein the timer varies at least one of the following timing parameters relating- to said display: a vertical synchronisation, a horizontal synchronisation, data, pixel rate.

22. The video or image display device according to claim 21, wherein the timer varies a timing of pulses of the vertical synchronisation signal, thereby controlling a duty cycle of a refresh operation.

23. The video or image display device according to claims 17, wherein the at least one image parameter relating to said image to be displayed includes a number of colours, or shades of colours, in an image to be displayed.

24. The video or image display device according to claims 17, the device further comprising a memory device, for example comprising a lookup table or an arithmetic function, that stores information relating to the at least one image parameter.

25. The video or image display device according to claim 24, wherein said processor determines a minimum refresh rate equating to a maximum allowable flicker of the displayed image and stored said refresh rate in said memory device, said refresh rate extracted from said memory device by said processor to vary said display refresh at a rate to avoid substantially any perceptual flickering of said displayed image.

26. The video or image display device according to claims 17, wherein the means for varying a refresh rate is responsive to the display receiving a new image or portion of image to be displayed.

27. The video or image display device according to claims 17, wherein said image on said display is refreshed by refreshing at least one of:
a portion of an image,
a full-screen image,
an image by means of a row-by-row refresh,
an image by means of an interleave refresh operation.

28. A display driver adapted to control the refresh rate of a display device according to claims 17.
